(19) United States
(12) Patent Application Publication
(10) Pub. No.: US 2015/0304423 A1
(43) Pub. Date: Oct. 22, 2015

(54) COMPUTER SYSTEM

(71) Applicant: Hitachi, Ltd., Tokyo (JP)

(72) Inventors: Ai SATOYAMA, Tokyo (JP); Yoshiaki EGUCHI, Tokyo (JP)

(21) Appl. No.: 14/657,287

(22) Filed: Mar. 13, 2015

Related U.S. Application Data
(63) Continuation of application No. PCT/JP2014/061125, filed on Apr. 21, 2014.

(51) Int. Cl. H04L 29/08; G06F 9/455

(52) U.S. Cl. CPC H04L 67/1097; H04L 67/16; G06F 9/455

(57) ABSTRACT

A computer system includes a first server computer, a second server computer, a nonvolatile memory device, and a storage controller connected to the first server computer and the second server computer via PCI-Express, and connected to the nonvolatile memory device. The storage controller provides a storage area in the nonvolatile memory device as a shared data area for the first server computer and the second server computer. A server computer, which is each of the first and second server computers, stores a program that issues an NVM-Express command that is a command conforming to an NVM-Express standard. The program instructs the server computer to access the shared data area via PCI-Express by instructing the server computer to issue the NVM-Express command that specifies a namespace associated with the shared data area.

### CROSS REFERENCE TO RELATED APPLICATIONS

This application claims priority to PCT/JP2014/061125 filed on Apr. 21, 2014, the entire contents of which are incorporated by reference herein.

### TECHNICAL FIELD

The present invention relates to a computer system including a nonvolatile memory device.

### BACKGROUND ART

Flash memory devices (hereinafter referred to as flashes) provide higher I/O (Input/Output) performance than HDDs (Hard Disk Drives). However, in connection with provision of the performance of the flash memory device, conventional SCSI (Small Computer System Interfaces) involves inefficient processing executed in a server by programs such as an OS (Operating System) and device drivers. Thus, providing the high I/O performance of the flash memory device is not easy. NVM-Express (Non-Volatile Memory Express; hereinafter abbreviated as NVMe) described in PTL1 is a standard that specifies the following in order to solve the above-described problem.

This specification defines a streamlined set of registers whose functionality includes:
Indication of controller capabilities
Status for controller failures (command status is processed via CQ directly)
Admin Queue configuration (I/O Queue configuration processed via Admin commands)
Doorbell registers for scalable number of Submission and Completion Queues

Key points for NVMe are as follows.
Does not require uncacheable / MMIO register reads in the command submission or completion path.
A maximum of one MMIO register write is necessary in the command submission path.
Support for up to 65,535 I/O queues, with each I/O queue supporting up to 64K outstanding commands.
Priority associated with each I/O queue with well-defined arbitration mechanism.
All information to complete a 4KB read request is included in the 64B command itself, ensuring efficient small I/O operation.
Efficient and streamlined command set.
Support for MSI/MSI-X and interrupt aggregation.
Support for multiple namespaces.
Efficient support for I/O virtualization architectures like SR-IOV.
Robust error reporting and management capabilities.
Support for multi-path I/O and namespace sharing.

Furthermore, NPL 1 discloses the concept that a namespace (hereinafter abbreviated as an NS) is shared by a plurality of hosts.

NPL 2 discloses that the I/O performance of the server is improved by using a PCI-Express flash memory SSD (Solid State Drive) that interprets commands conforming to NVMe as described above (hereinafter abbreviated as NVMe commands).

### CITATION LIST

### Non Patent Literature

[NPL 1]

“NVM Express 1.1a Specification,” http://www.nvmexpress.org/wp-content/uploads/NVM-Express-1_{—}1a.pdf

[NPL 2]

“NVM Express: Unlock Your Solid State Drives Potential,” http://www.nvmexpress.org/wp-content/uploads/2013-FMS-NVMe-Track.pdf

### SUMMARY OF INVENTION

### Technical Problem

The NVMe standard disclosed in NPL 1 discloses the concept of NS sharing, but fails to disclose an implementation as described below. Providing a computer system that implements high-performance I/O is not easy.

### “1.3 Outside of Scope

The register interface and command set are specified apart from any usage model for the NVM, but rather only specifies the communication interface to the NVM subsystem. Thus, this specification does not specify whether the non-volatile memory system is used as a solid state drive, a main memory, a cache memory, a backup memory, a redundant memory, etc. Specific usage models are outside the scope, optional, and not licensed.”

### Solution to Problem

To solve the above-described problem, a computer system includes a first server computer, a second server computer, a nonvolatile memory device, and a storage controller connected to the first server computer and the second server computer via PCI-Express, and connected to the nonvolatile memory device. The storage controller provides a storage area in the nonvolatile memory device as a shared data area for the first server computer and the second server computer. A server computer, which is each of the first and second server computers, stores a program that issues an NVM-Express command that is a command conforming to an NVM-Express standard. The program instructs the server computer to access the shared data area via PCI-Express by instructing the server computer to issue the NVM-Express command that specifies a namespace associated with the shared data area.

### BRIEF DESCRIPTION OF DRAWINGS

[FIG. 1]

FIG. 1 is a diagram depicting a summary of an embodiment.

[FIG. 2]

FIG. 2 is a diagram depicting a physical configuration and a logical configuration of a CPF.

[FIG. 3]

FIG. 3 is a diagram depicting a physical configuration and a logical configuration of another CPF.

[FIG. 4]

FIG. 4 is a diagram depicting details of the CPF in which an NVMe interpretation section is a candidate (3).

[FIG. 5]

FIG. 5 is a diagram depicting a PCIe space in a server-side PCIe I/F device.

[FIG. 6]

FIG. 6 is a diagram depicting a relation between NVMe NSs and storage areas in a storage controller.

[FIG. 7]

FIG. 7 is a flowchart depicting a process related to an NVMe command.

[FIG. 8]

FIG. 8 is a flowchart depicting a method for booting the CPF.

[FIG. 9]

FIG. 9 is a diagram depicting details of the CPF in which the NVMe interpretation section is a candidate (2).

[FIG. 10]

FIG. 10 is a diagram depicting an example of an application of the CPF.

### DESCRIPTION OF EMBODIMENTS

An embodiment will be described below with reference to the drawings. However, the present embodiment is only an example of implementation of the invention and is not intended to limit the technical scope of the invention. Furthermore, components common to the drawings are denoted by the same reference numerals.

Information in the present embodiment will be described using an expression “table”. However, the information need not necessarily be expressed in a data structure based on a table. For example, the information may be expressed in a data structure such as a “list”, a “DB (Database)”, or a “queue” or using any other structure. Thus, to indicate independence of the data structure, the “table”, the “list”, the “DB”, the “queue”, and the like may be simply referred to as “information”. Furthermore, when the contents of each type of information are described, expressions “identity”, “identifier”, “name”, and “ID” may be used and are interchangeable.

The subject in the description below is a “program”. However, the subject in the description may be a CPU (Central Processing Unit) because the program is executed by the CPU to execute a defined process using a memory and a communication port (communication control apparatus). Furthermore, processes disclosed using a program as the subject may be processes executed by a computer such as a server computer, a storage computer, or a management computer, or an information processing apparatus. Some or all of the programs may be realized by dedicated hardware or modularized. The various programs may be installed in each computer via a program distribution server or storage media.

### SUMMARY OF THE EMBODIMENT

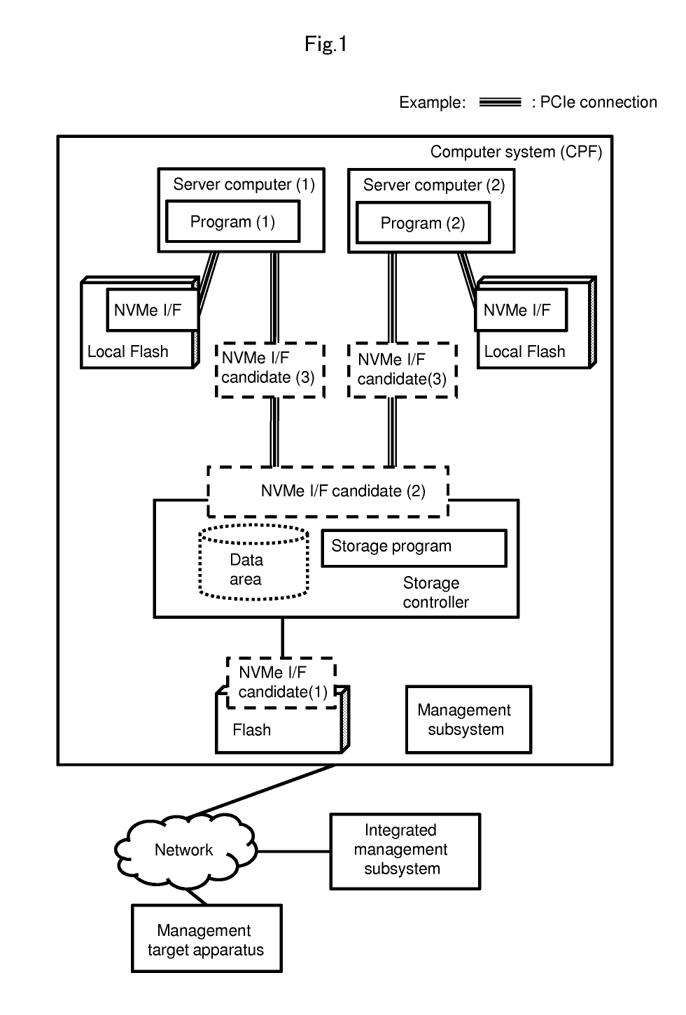

FIG. 1 depicts a summary of the present embodiment. The description below is applicable to succeeding standards for NVMe which will emerge in the future and similarly to succeeding standards for PCI-Express (Peripheral Component Interconnect Express; hereinafter abbreviated as PCIe). When a term related to NVMe or PCIe is used, the term may be considered to indicate an equivalent term for succeeding standards for NVMe or PCIe. Similarly, the description of the embodiment is intended for NVMe targeted for block accesses. However, of course, if accesses in bytes or words are specified in the NVMe standard, the present embodiment is applicable to those accesses. Similarly, the description of the present embodiment is intended for a nonvolatile memory device using a flash memory, but the present embodiment is applicable to nonvolatile memories other than flash memories, for example, nonvolatile memory devices using FeRAM (Ferroelectric Random Access Memory), MRAM (Magnetoresistive Random Access Memory), phase change memory (Ovonic Unified Memory), or RRAM (registered trade mark; Resistance RAM).

### NVMe

As described in NPL 1 and NPL 2, NVMe is an I/F (Interface) standard for implementing high-speed accesses to a flash memory SSD. Developing programs (including, for example, device drivers, applications, and OSs) in accordance with the NVMe standard enables high-speed accesses to the flash memory SSD involving high IOPS (Input/Output per Second) and low latency. For example, NPL 2 discloses, in page 18, that an access latency of 6.0 μs measured in an SSD adopted for SCSI/SASs (Serial Attached SCSIs) can be reduced to 2.8 as by adopting NVMe. The key points for the reduction are as described above. NVMe uses multi I/O queues to avoid sharing of one I/O queue among a plurality of cores, allowing improvement of the efficiency of memory accesses among CPU cores.

NVMe is expected to be standardized so that a variety of flash memory devices conform to the NVMe standard. Thus, venders of programs other than device drivers (typically application programs) can expect the vender's programs to directly issue an NVMe command to access a flash memory device.

The “flash memory device” in the present embodiment has at least the following features . A flash memory SSD is an example of such a flash memory device:
The flash memory device includes a flash memory chip.
The flash memory device includes a flash memory controller that executes the following processes:
   The flash memory controller transfers data saved in the flash memory chip to the outside in accordance with an external read request. The flash memory controller saves data received along with the externally received write request to the flash memory chip.
   The flash memory controller executes an erase process of the flash memory chip.

### Computer System

The computer system at least includes one or more server computers, one or more storage controllers, a flash memory device (which may be abbreviated as “Flash” in the figures), and a communication mechanism. The contents of the computer system may each be referred to as a computer system component.

The present computer system is preferably a converged platform. The converged platform is also referred to as a converged infrastructure or a converged system. In Japanese, “converged” may be replaced with “vertical integration”. In the present embodiment, these will be collectively referred to as converged platforms (which may be abbreviated as CPFs). The CPF has the following features:
Products including a server computer, a storage system (including a storage controller and a storage device), and a communication mechanism that connects the server computer and the storage system together. Upon individually introducing a server computer and a storage system into a company, a manager of the company performs operation verification represented by a check on the connection between the server computer and the storage system. However, when introducing the CPF, because vendors sell the products pre-perform the operation verification, it achieves elimination or reduction of the need for a manager of a client that installs and uses the products to perform the operation verification.
Some CPFs include a management subsystem executing a management program that collectively configures the server computer, the storage system, and the communication mechanism. The management subsystem can quickly provide an execution environment (a virtual machine, a DBMS: Database Management System, a Web server, or the like) desired by the manager. For example, to provide a virtual machine with needed amounts of resources, the management program requests the server computer and the storage system to allocate needed resources for the virtual machine and requests a hypervisor to create the virtual machine using the allocated resources.

### Server Computer

Server computers (1) and (2) are units storing and executing programs (1) and (2), respectively, which access the storage controller. The programs (1) and (2) issue an NVMe command to access a shared data area provided by the storage controller. Parts of the shared data area which are provided as NVMe NSs will be described.

The server computer at least includes a CPU, a main memory (hereinafter abbreviated as a memory), and an RC. The server computer may be, for example, as follows:
File server
Blade server system
PC (Personal Computer) server
Blade inserted into the blade server system

### Programs for the Server Computer

The programs (1) and (2) are, for example, business application programs (for example, Web servers, DBMSs, analysis programs, or middleware), programs that enable LPAR (Logical Partitioning) or a virtual machine to be created, OSs, or device drivers or may be other programs.

### Communication Mechanism

The communication mechanism connects the server computer and the storage controller based on PCIe. The PCIe connection between the server computer and the storage controller involves no network such as an FC (Fiber Channel) or an SAN (Storage Area Network) using Ethernet (registered trademark) which is adopted for a conventional connection between a server computer and a storage system. The reasons are as follows (one or both of the reasons):
A protocol that enables such a wide-area SAN to be constructed has high overhead in conversion processes, hindering provision of high-performance inputs to and outputs from the shared data area.
Devices (particularly switches) for Ethernet and the SAN are expensive.

NVMe assumes the communication mechanism based on PCIe. Thus, a section of the server computer that interprets NVMe commands needs to be an endpoint (hereinafter abbreviated as an EP) in accordance with PCIe. Furthermore, if a PCIe chip set does not permit a plurality of root complexes (hereinafter abbreviated as RCs) to share an EP (this is hereinafter referred to as “coexistence of a plurality of RCs”) (for example, if the PCIe chip set does not support MR-IOV: Multi-Root I/O Virtualization), this limitation needs to be taken into account.

Based on the above description, the present embodiment discloses three candidates for the section that interprets NVMe commands. The computer system may include one of the three candidates. The three candidates (1), (2), and (3) (represented as NVMe I/F candidates (1), (2), and (3) in the figures) are as follows:
Candidate (1): The flash memory device. In this case, the storage controller and the flash memory device are connected together based on PCIe, and the flash memory device serves as an EP with functions conforming to NVMe. The storage controller passes an NVMe command from the server computer to the flash memory device.
Candidate (2): The storage controller. In this case, the storage controller and the flash memory device are connected together based on PCIe. If the coexistence of a plurality of RCs is limited, the PCIe connection between an RC in the server computer (1) and an RC in the storage controller is separated from the PCIe connection between an RC in the server computer (2) and the RC in the storage controller. The RC in the storage controller provides individual endpoints to the RCs in the respective server computers.
Candidate (3): An intermediate device that intermediates between a PCIe connection from the server computer and a PCIe connection from the storage controller. Because CPUs and PCIe chip sets provided by Intel (R) and AMD (R) are commoditized, these are inexpensive and deliver high performance. A possible problem with the adoption of such a CPU or a PCIe chip set is that the RC is also present in the storage controller to prevent a direct connection between the server computer and the storage controller when the coexistence of a plurality of RCs is limited as described above. The intermediate device solves this problem by including a logic that provides an endpoint to the RC in each of the server computers, a logic that provides another EP to the RC in the storage controller, and a logic that intermediates transfer of write data and read data between the server computer and the storage controller.

Because PCIe has been widely used as a communication path inside the server computer and inside the storage controller, it achieves a shorter communication enabled distance than FC and Ethernet, and the number of EPs that can communicate with the RC is smaller than the number of communication nodes that can communicate using FC or Ethernet. Furthermore, PCIe achieves only weaker failure management than communication protocols operating on FC and Ethernet. Thus, the present computer system adopting PCIe as a communication mechanism is preferably a CPF. Treating the computer system as the CPF eliminates the need for cabling of the communication mechanism among the server computer and the storage unit so that it suppress trouble associated with the above-described disadvantages of PCIe, and allowing reliable NVMe accesses to be provided.

### Advantages of Each NVMe Command Interpretation Section

The candidates (1) to (3) for the section that interprets NVMe commands have, for example, the following advantages.
Candidate (1): Processing executed by the storage controller has no or low overhead. The candidate (1) is easy to realize efficient NVMe queue control with taking the internal status of the flash memory device into account. This is because the section that interprets NVMe commands is the same as or close to a controller that performs wear leveling, reclamation, and the like for the flash memory device. For example, a plurality of I/O queues is present in accordance with NVMe, the candidate (1) changes a manner of retrieving NVMe commands from a plurality of I/O queues based on the internal status.
Candidate (2): Enterprise functions provided by the storage controller can be applied to the NVMe NSs. Furthermore, the candidate (2) can perform efficient NVMe queue control taking the internal status of the storage controller into account. This is because the section that interprets NVMe commands is the same as or close to the storage controller. For example, the candidate (2) can change a manner of retrieving NVMe commands from a plurality of I/O queues based on the internal status, and further can change control of other processes executed by the storage controller based on an accumulation state of NVMe commands in the I/O queues.
Candidate (3): Enterprise functions provided by the storage controller can be applied to the NVMe NSs. Furthermore, if the intermediate device as the candidate (3) converts an NVMe command into a SCSI request, storage programs executed by the storage controller easily remain compatibility with storage programs in a conventional SAN storage subsystem at the level of execution code, intermediate code, or source code. This allows an improvement of the quality and functions of the storage programs in the computer system, and facilitates implementation of cooperative processing between the storage controller of the computer system and the SAN storage subsystem such as the remote copying. This is because the cooperative processing is mostly the same as the normal cooperation between the SAN storage subsystems.

### Storage Controller

The storage controller uses a storage area in the flash memory device to provide high-performance I/O processing. Furthermore, the storage controller may have functions related to such reliability, redundancy, functionality, and maintainability and manageability as provided by enterprise SAN subsystems. Examples are as follows:
The storage controller makes the flash memory device redundant and provides a shared data area from the redundant storage area. Furthermore, the storage controller enables device maintenance such as replacement, expansion, and removal of the flash memory device without the need to inhibit accesses to the data stored in the shared data area or to force the accesses to fail (what is called non-stop) . Unlike HDDs, the flash memory device is characterized in that device lifetime is shortened by excessive write to the device. Thus, the storage controller provides such redundancy and non-stop maintenance so that the reliability of the present computer system is improved. Additionally, when a PCIe flash memory device is inserted into the server computer, the maintenance of the flash memory device needs to be individually performed on the respective server computers. However, when the flash memory device is connected to the storage controller as is the case with the present computer system to concentrate the maintenance of the storage controller on the storage side, a maintenance operator can collectively perform maintenance work on the flash memory device and easily carry out maintenance.
The storage controller provides copy functions such as remote copying and snapshot for data stored based on NVMe.
The storage controller is connected to an HDD as s storage device besides the flash memory device to enable tiering using the storage device. The storage controller may associate the storage area provided by the HDD with the NVMe NSs.
The storage controller provides accesses from a computer system (including a server computer and a storage controller) outside the present computer system or accesses from a network apparatus (including a SAN switch or an Ethernet switch) via a network, without via the server computer (1) or (2). This leads to improved flexibility, such as enabling of the above-described remote copying and provision of storage consolidation including the computer system or the network apparatus, which are outside the present computer system.

### Arrangement of the Server Computer and the Storage Controller

As described above, the communicable distance of PCIe is short, the server computer and the storage controller may be arranged at physically close positions. However, the following configuration is more preferable:
The storage controller is configured to be inserted into a chassis of the blade server system. When a substrate such as a backplane is used for a PCIe connection between the storage controller and a blade that is the server computer, trouble associated with the PCIe connection can be reduced.
The storage controller is placed in a chassis different from the chassis of the blade server system. Both chassis are connected together via a cable for PCIe connections. One rack, in which the chassis of the blade server system and the chassis of the storage controller are placed, may be sold as a CPF. Such manner, placing both chassis and the cable for PCIe connection in the rack, enables a reduction in trouble associated with the cable for PCIe connection, and makes it easy to divert the chassis itself of the blade server system or the storage system sold alone or a component of the blade server system or the storage system sold alone.

### Management Subsystem

The management subsystem executes at least one of the following processes:
Receiving a request from an administrator or an integrated management subsystem and configuring computer system components in accordance with the request.
Acquiring information from the computer system components and displaying the information to the administrator or transmitting the information to the integrated management subsystem. The acquired information includes, for example, performance information, fault information, setting information, and configuration information. For example, the configuration information includes items fixed to the present computer system unless the components are removed from and then installed in the computer system, and changeable items. The setting information is a changeable item in the configuration information by the configuration (i.e. setting). These types of information may be collectively referred to as component information. Furthermore, the information displayed to the administrator or transmitted to another computer may be the acquired component information itself or may be converted or processed based on certain criteria before the display or transmission of the information.
What is called automatic and autonomous management in which the management subsystem automatically and autonomously configures the computer system components based on the component information.

The management subsystem may be in one or mixture of the following forms. However, the management subsystem is not limited to these forms and may be in any form in which the management subsystem executes the above-described processes. A set of relevant functions and computers corresponds to the management subsystem.
One or more computers different from the computer system components. If the management subsystem corresponds to a plurality of computers connected to the computer system via a network, a computer exclusively used as a server computer, a computer exclusively used as a storage controller, and a computer exclusively used for a display process may be present in the management subsystem, for example.
Some of the computer system components. For example, a BMC (Baseboard Management Controller) and an agent program correspond to the management subsystem.

### Integrated Management Subsystem

The integrated management subsystem is a subsystem that integrally manages management target apparatuses typified by the server, the storage system, the network apparatus (including an SAN switch or an Ethernet switch), and the present computer system. The integrated management subsystem is connected to the management subsystem and the other management target apparatuses via the network. The integrated management subsystem may communicate with any of the management target apparatuses in accordance with a vender-proprietary protocol in order to manage the plurality of management target apparatuses or may communicate in accordance with a standardized protocol such as SNMP (Simple Network Management Protocol) or SMI-S (Storage Management Initiative-Specification).

The integrated management subsystem includes one or more computers connected to the computer system via the network.

A vendor providing the integrated management subsystem may be different from the vendor of the present computer system. Since the communication mechanism of the present computer system is a PCIe communication mechanism, in that case, the integrated management subsystem may fail to manage the present computer system, or even if the integrated management subsystem can manage the present computer system, the management may be inferior to the normal management. An example of the reason is that the integrated management subsystem may exclusively recognize an FC or Ethernet connection as the connection path between the server computer and the shared storage controller and fail to recognize a PCIe connection as the connection path. In this case, the integrated management subsystem does not consider the server computer and the shared storage controller to be connected together, but consider that each server computer treat the shared storage controller as the local flash memory device. Thus, management items assuming the presence of such connection information are not applicable to the present computer system.

For measures against such a case, the management subsystem of the present computer system may cause the PCIe connection of the present computer system to emulate an SAN connection. The management subsystem thus may converts information on the PCIe connection into information on the virtual SAN connection and transmits the information on the SAN connection to the integrated management subsystem. Then, the integrated management subsystem may consider the SAN connection to be a management target. The emulation of the SAN connection may be, for example, provision of connection information or acceptance of configuration for the SAN connection (allocation of logical units to storage ports). The SAN to be emulated may be an FC-SAN, an IP (Internet Protocol)-SAN, or an Ethernet-SAN.

### Applications of the Present Computer System and Combined Use of a Local Flash Memory Device

As described above, the present computer system may be introduced in order to realize data sharing among a plurality of server computers based on NVMe. Or, the present computer system may be introduced in order to apply enterprise functions provided by the above-described storage controller to data stored based on NVMe, without the data sharing. Or, if a business system has already been constructed using a program that issues NVMe commands in an environment different from the present computer system, the present computer system may be able to construct the business system, without implementing an interface for a vender-proprietary flash memory device to the program.

The data sharing based on NVMe has, for example, the following uses:
High-speed fail-over among a plurality of server computers. In response to a fault of the server computer (1) or the like, the server computer (2) determines to perform fail-over to take over processing executed by the server computer (1). If each of the plurality of server computers is connected to local flash memories (abbreviated as “Local flashes” in the figures) via a PCIe connection, and a destination of NVMe commands issued by the programs in the server computer is only to the local flash memory devices, the plurality of server computers needs to copy data between a fail-over source local flash memory device and a fail-over destination local flash memory device. This makes high-speed fail-over difficult. The present computer system does not need such data copying.
A case where a plurality of server computers executes parallel processing by accessing the shared data area in parallel based on NVMe. A certain server computer writes data, and then, another server computer can read the data immediately.

However, when the number of server computers increases, the I/O processing capability of the storage controller maybe a bottleneck.

For measures against such a case, each of the server computers may be connected to a flash memory device that can interpret NVMe commands (which is referred to as a local flash memory device) based on PCIe, and such local flash memory device may be occupied by the connected server computer. In such a configuration, the program executed by the server computer, may store un-sharing data or data unneeded to apply enterprise functions, in the local flash memory devices, and the program may store data to be shared or data needed to apply enterprise functions, in the NVMe NSs being storage areas provided by the storage controller. For example, in a configuration in which the server computer (2) takes over processing executed by the programs in the server computer (1) as a result of, for example, a fault in or a load on the server computer (1), the server computer (1) executes processing, by writing data needed for the takeover to the NSs being the shared data area and reading the data from the NSs, and writes data unneeded for the takeover to the local flash memory device.

Such configuration may be manually performed but may be automatically carried out by the above-described management subsystem or the integrated management subsystem. For example, these subsystem may be configured to determine whether or not each of the NSs can be shared by a plurality of server computers (or enterprise functions can be applied to the NS), to determine data that need to be shared (or to which the enterprise functions need to be applied) based on a characteristic of programs executed by the server computers, and to configure the programs executed by the server computers for using properly the storage area to store data of the program. Because the administrator for the programs does not necessarily know the configuration and features of the present computer system well, administrator's workload of configuration of the programs is reduced. A method for determining whether or not the NS can be shared is as follows, but any other method may be used:
The management subsystem inquires to the computer system of the relations between NSIDs and the storage areas of the storage controller.
Whether the NS can be shared by the server computers is determined based on information obtained by a program in the server computer by specifying the NSIDs to collect information.

### Basic Configuration Diagram

A further detailed embodiment will be described taking, as an example, a case where the computer system is a CPF.

CPF under NVMe Control

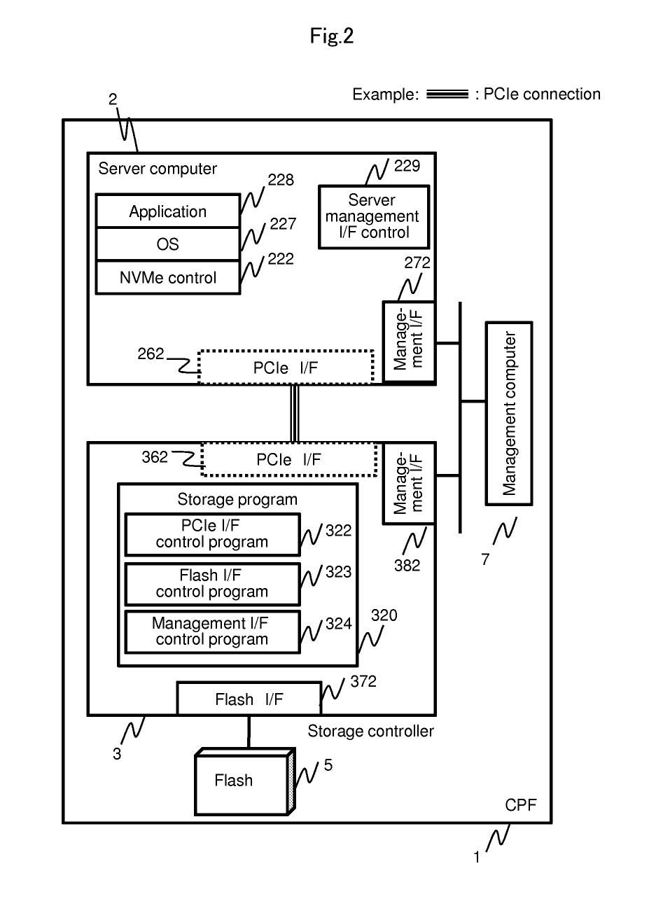

FIG. 2 is a diagram depicting a physical configuration and a logical configuration of the CPF.

The CPF 1 in FIG. 2 includes a server computer 2, a storage controller 3, a flash memory device 5 serving as a storage device, and a management computer 7 that is an example of the management subsystem.

The server computer 2 includes a management I/F 272 for connection to the management computer 7. The server computer 2 executes an application program 228 (which may be simply abbreviated as an application), an OS 227, an NVMe control program 222, and a server management I/F control program 229 that are examples of the programs. The connection between the management computer 7, the server computer 2 and the storage controller 3 is expected to be based on Ethernet but may be in any other physical or virtual connection form. The server management I/F control program 229 controls the management I/F 272 to communicate with the management computer 7.

The NVMe control program 222 is a program that issues NVMe commands to a PCIe I/F 262. The program 222 may be a part of other program stored in the server computer 2 or a program different from the other program stored in the server computer 2. For example, the application program 228 may issue NVMe commands or device drivers in the OS 227 may issue NVMe commands.

The PCIe I/F 262 transmits an NVMe command to a PCIe I/F 362 in accordance with operation of the NVMe control program 222, and then receives a response to the NVMe command from the PCIe I/F 362. The PCIe I/F 262 returns the response to the NVMe control program 222.

The storage controller 3 includes a management I/F 382 for connection to the management computer 7 and a flash I/F 372 for connection to the flash memory device 5. The connection between the flash I/F 372 and the flash memory device 5 is preferably a PCIe connection if the flash memory device 5 interprets NVMe commands. Otherwise, the connection may be based on SAS, SATA (Serial Advanced Technology Attachment), FC, or Ethernet or any other communication mechanism may be used.

The storage controller 3 executes a storage program 320. The storage program 320 includes, for example, a PCIe I/F control program 322, a flash I/F control program 323, and a management I/F control program 324 that control communications with the respective interfaces. The PCIe I/F control program 322 controls the PCIe I/F 362 to communicate with the server computer 2. The flash I/F control program 323 controls the flash I/F 372 to communicate with the flash memory device 5. The management I/F control program 324 controls the management I/F 382 to communicate with the management computer 7.

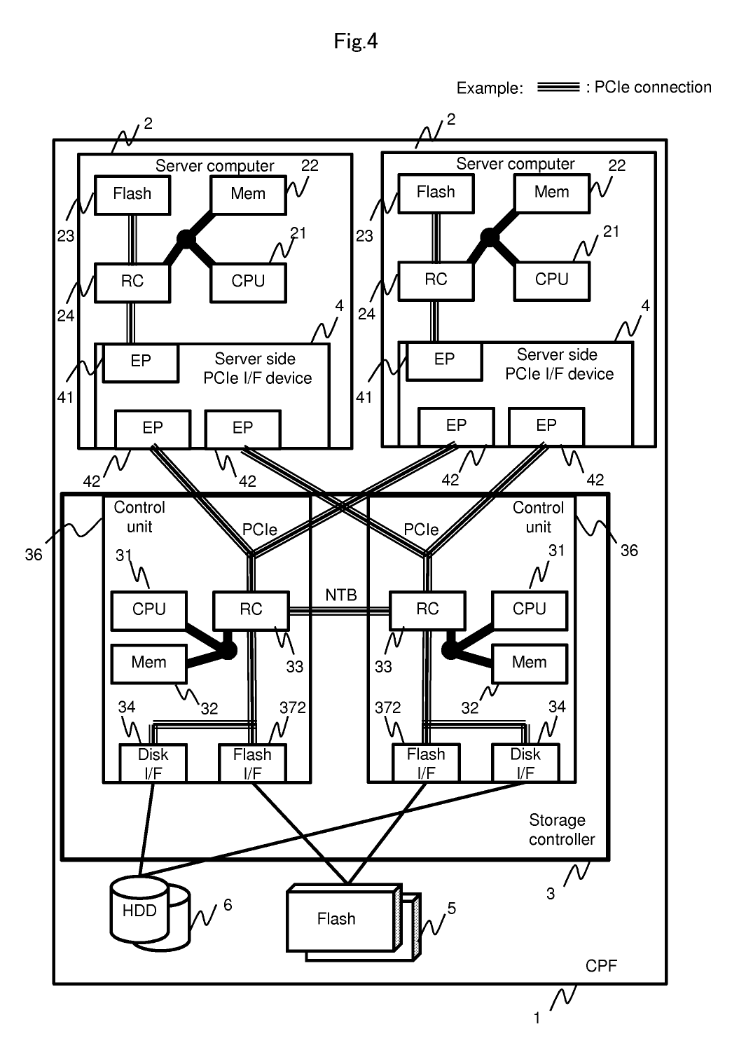

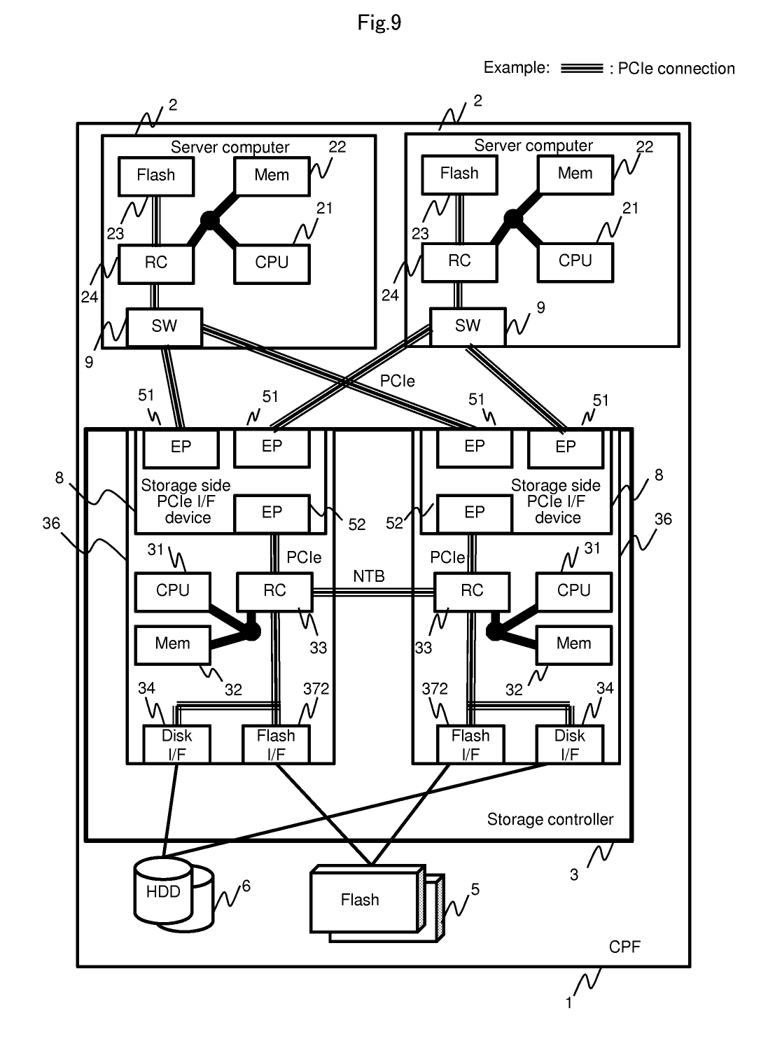

The substances of the PCIe I/F 262 and the PCIe I/F 362 are, for example, a server side PCIe I/F device 4 depicted in FIG. 4 and a storage side PCIe I/F device 8 depicted in FIG. 9.

CPF under NVMe Control +SCSI Control

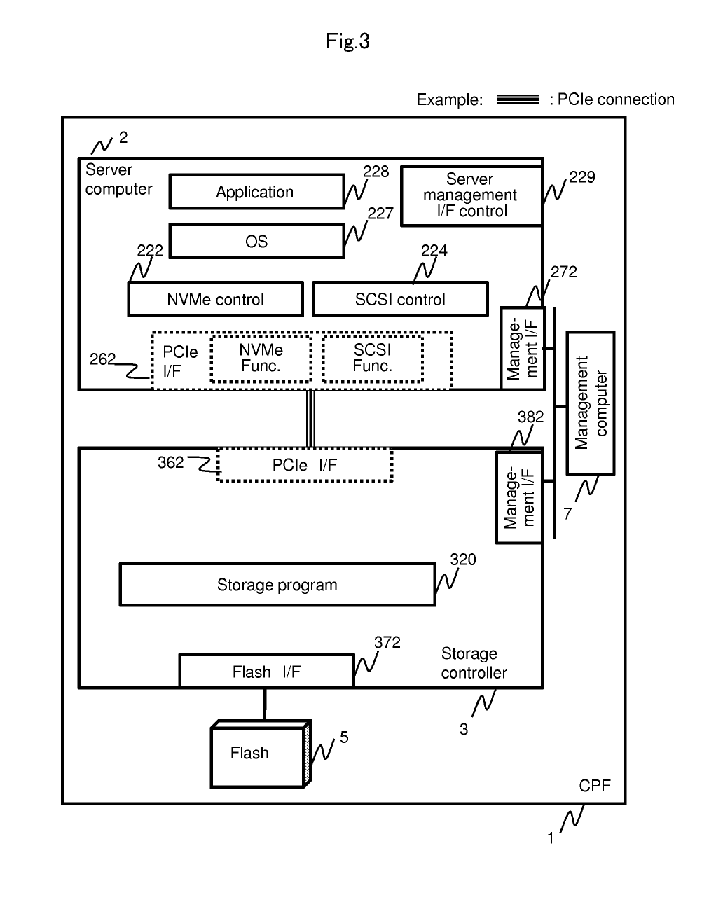

FIG. 3 is other diagram depicting a physical configuration and a logical configuration of the CPF.

A difference from FIG. 2 is that both NVMe and SCSI are used for I/O requests from the server computer 2 to the storage controller 3.

An SCSI control program 224 issues a SCSI request for a LUN provided by the storage controller 3 to a SCSI function (SCSI Func. in the figures) of the PCIe I/F 262 in accordance with a request from other program. The SCSI control program 224 is, for example, a SCSI device driver. The SCSI control program 224 may be apart of other program stored in the server computer 2 or a program different from the other program stored in the server computer 2. For example, a device driver in the OS 227 may issue SCSI requests.

To accept both an NVMe command and a SCSI command, the PCIe I/F 262 needs to have two functions, an NVMe function (NVMe Func. in the figures) and a SCSI function. Of the two functions, the NVMe function has been described in the description of the PCIe I/F 262 in FIG. 2. The SCSI function transmits a SCSI command to the PCIe I/F 362 in accordance with operation of the SCSI control program 224, and then receives a response to the SCSI command from the PCIe I/F 362. The SCSI function then returns the response to the SCSI control program 224. Whether or not the PCIe I/F 362 has multiple functions depends on whether the intermediate device interprets NVMe commands.

A server computer 2 being able to issue both NVMe commands and SCSI commands has at least one of the following advantages.
NVMe-incompatible programs in the server computer 2 are enabled to access the storage areas corresponding to the NVMe NSs.
NVMe-incompatible programs in the server computer 2 are enabled to access a storage area different from the storage areas corresponding to the NVMe NSs. For example, when an HDD is connected to the storage controller 3, the server computer 2 is enabled to access a storage area in the HDD based on SCSI.
At the point in time of filing of the application, NVMe I/Fs have not been standardized to be able to use the NSs as a boot device for the server computer 2. Thus, when the storage area provided by the storage controller 3 is used as a boot device for the server computer 2, the server computer 2 needs to be able to access the storage area using a SCSI request. The booting of the server computer 2 means that a BIOS (Basic Input/Output System) program for the server computer 2 needs to be implemented so as to be able to handle an EP with the boot device. The EP in this case is, for example, a SCSI HBA (Host Bus Adapter) or a PCIe I/F device (NVMe function or SCSI function). A specific method for implementing the EP is as follows:
   The BIOS program acquires a device driver program for the BIOS program from a discovered EP and executes the device driver program.
   The BIOS program itself includes a driver program for NVMe.

The server computers 2 are classified into the following three types:
(A) A type that issues NVMe commands but does not issue SCSI requests.
(B) A type that issues both NVMe commands and SCSI commands.
(C) A type that does not issue NVMe commands but issues SCSI commands.

Here, the CPF 1 may include one server computer 2 or a plurality of server computers 2. When the CPF 1 includes a plurality of server computers 2, the server computers 2 included in the CPF 1 may be of one of the types (A) to (C), a combination of any two of the types (A) to (C), or a combination of the three types (A) to (C).

### General Hardware Configuration of the CPF Using the Candidate (3)

FIG. 4 is a diagram depicting the details of the CPF 1 in which the above-described NVMe interpretation section is the candidate (3). The PCIe connection between the server computer 2 and the storage controller 3 is made via a switch, but this is omitted in FIG. 4.

The server computer 2 includes a CPU 21, a main memory 22 (abbreviated as Mem in the figures and hereinafter sometimes referred to as a memory 22), an RC 24, and a server side PCIe I/F device 4. The RC 24 and the server side PCIe I/F device 4 are connected together based on PCIe. The RC 24 and the CPU 21 are connected together by a network that operates faster than a PCIe network. The memory 22 is connected by a high-speed network to the CPU 21 and the RC 24 via a memory controller not depicted in the drawings. The above-described programs executed by the server computer 2 are loaded into the memory 22 and executed by the CPU 21. The CPU 21 may be a CPU core. The RC 24 and the CPU 21 may be integrated together into one LSI package.

The server side PCIe I/F device 4 is an example of the above-described intermediate device. The server side PCIe I/F device 4 may be arranged outside the server computer 2. The server side PCIe I/F device 4 has the following features:
The server side PCIe I/F device 4 interprets NVMe commands issued by the programs executed by the CPU 21.
The server side PCIe I/F device 4 provides an EP 41 to the RC 24.
The server side PCIe I/F device 4 provides another EP 42 to an RC 33 included in the storage controller 3. When the storage controller 3 needs to include a plurality of RCs and the server side PCIe I/F device 4 needs to communicate each of the RCs, the server side PCIe I/F device 4 provides different EPs 42 to the respective RCs. In this case of figure, the server side PCIe I/F device 4 provides two EPs 42 to the respective two RCs 33 in the storage controller 3.

To implement these features, the server side PCIe I/F device 4 may include a logic that provides a plurality of EPs 42 corresponding to the respective plurality of server computers 2, a logic that provides the EP 41, and a logic that issues a SCSI command based on an NVMe command to the storage controller 3. The EP 41 corresponds to the PCIe I/F 262 in FIG. 2, and the EP 42 corresponds to the PCIe I/F 362. Moreover, the server side PCIe I/F device 4 may include a logic that issues a SCSI request based on a SCSI request issued by the CPU 21 to the storage controller 3, as a logic corresponding to the SCSI function in FIG. 3. Each of the logics may be implemented by hardware such as a dedicated circuit or a processor that executes software.

The case where the server side PCIe I/F device 4 has both the NVMe function and the SCSI function has, for example, one or more of the following advantages compared to a case where these functions are implemented on different boards:
Costs are reduced.
A space in the server computer 2 is reduced into which a device for PCIe connection is inserted.
The number of PCIe slots used in the server computer 2 is reduced. In particular, when the above-described multiple functions are implemented in the candidate (3), the logic that allows the server side PCIe I/F device 4 to transmit a SCSI request to the storage controller 3 can be shared between the functions. This enables a reduction in the size and cost of the device.

The server computer 2 may include the local flash memory device 23 (abbreviated as Flash in the figures) as described above. The local flash memory device 23 is connected to the RC 24 based on PCIe.

For each of the types of components in the server computer 2, a plurality of components of that type may be included in the server computer 2. FIG. 4 depicts that the local flash memory device 23 and the server side PCIe I/F device 4 communicate with each other via the RC 24. However, the local flash memory device 23 and the server side PCIe I/F device 4 may communicate with each other without the RC 24 or may be unable to communicate with each other.

The storage controller 3 includes one or more (two in FIG. 4) control units 36 (abbreviated as CTL units in the figures). Each of the control units 36 includes a CPU 31, a main memory 32 (abbreviated as Mem in the figures and hereinafter referred to as a memory 32), an RC 33, and a flash I/F 372. The RC 33, the server side PCIe I/F device 4, and the flash I/F 372 are connected together based on PCIe. The RC 33 and the CPU 31 are connected together by a network that operates faster than PCIe. The main memory 32 is connected by a high-speed network to the CPU 31 and the RC 33 via a memory controller not depicted in the drawings. The programs such as the storage program 320 which are executed by the storage controller 3 as described above are loaded into the memory 32 and executed by the CPU 31. The CPU 31 may be a CPU core. The RC 33 and the CPU 31 may be integrated together into one LSI package.

Each of the control units 36 may include a disk I/F 34 for connection to the HDD 6. If the flash I/F 372 and the disk I/F 34 are of the same interface type, the two I/Fs may merge into a common I/F. The disk I/F 34 may be based on SAS, SATA, FC, or Ethernet or any other communication mechanism may be used.

FIG. 4 depicts that the flash I/F 372 (or the disk I/F 34) and the server side PCIe I/F device 4 communicate with each other via the RC 33. However, the flash I/F 372 (or the disk I/F 34) and the server side PCIe I/F device 4 may communicate with each other without the RC 33 or may be unable to communicate with each other. This also applies to the flash I/F 372 and the disk I/F 34.

For each of the types of components in the control unit 36, a plurality of components of that type may be included in the control unit 36.

The control units 36 can desirably communicate with each other. By way of example, FIG. 4 depicts that the RC 33 are connected together based on PCIe . When the RC 33 are connected together based on PCIe, an NTB (Non-transparent Bridge), which is not depicted in the drawings, is used for the connection. Any other mechanism may be used for communication between the control units 36.

### Range of a PCIe Space in the CPF Using the Candidate (3)

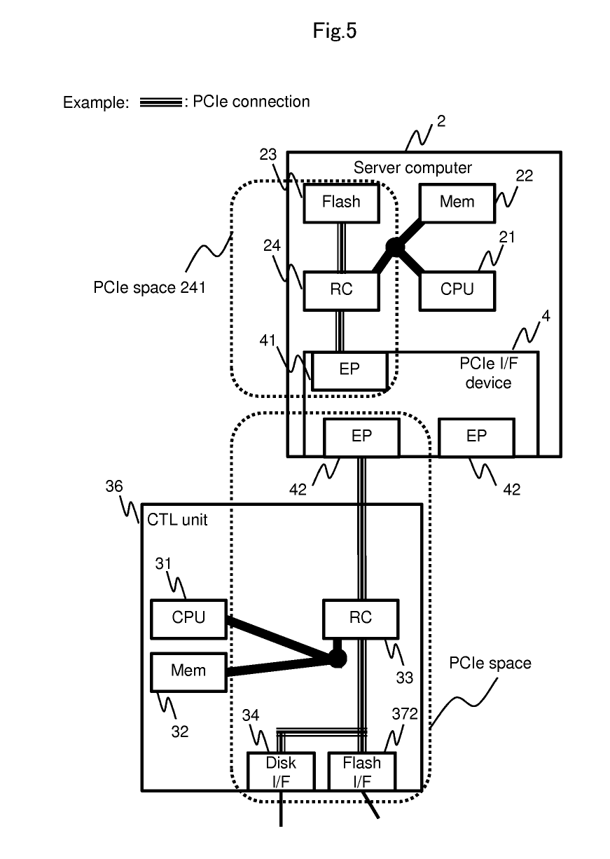

FIG. 5 is a figure that illustrates an enlarged FIG. 4 around the server side PCIe I/F device 4 and a PCIe space that is a space for PCIe address. A PCIe space 241 is a space controlled by the RC 24 in the server computer 2. A PCIe space 331 is a space controlled by the RC 33 in the storage controller 3. As noted in connection with the above-described “coexistence of a plurality of RCs” problem, the coexistence of a plurality of RCs in one PCIe space is impossible. Thus, to separate each PCIe space into parts of the PCIe space, the server side PCIe I/F device 4 can connect a PCIe link for the RC 24 and a PCIe link for the RC 33, and operates as an EP at each of the links.

The disk I/F 34 and the flash I/F 372 may be present in a PCIe space that is different from the PCIe space 331.

Relation Between the NVMe NSs and the Storage Areas in the Storage Controller

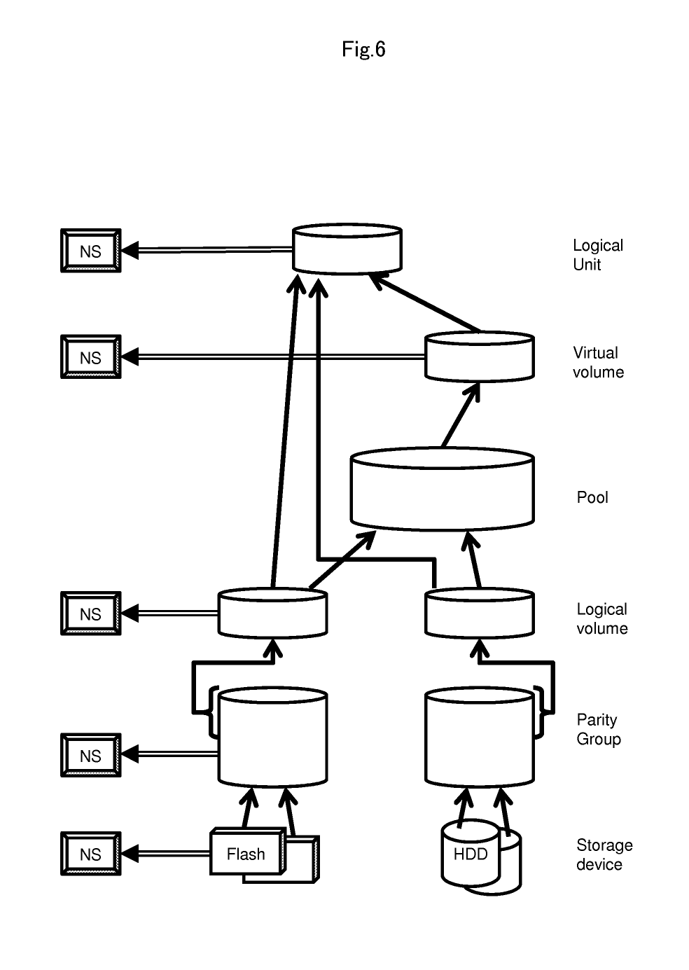

FIG. 6 is a diagram depicting the relation between the NVMe NSs and the storage areas in the storage controller 3. The storage controller 3 manages the following storage areas:
A parity group. The parity group is defined using a plurality of storage devices (the flash memory device 5 and the HDD 6). This allows high reliability, a high speed, and a large capacity to be achieved based on RAID (Redundant Arrays of Inexpensive Disks).
Logical volumes. The logical volumes are areas into which the storage area for the parity group is divided. The storage area for the parity group may have too large a capacity to directly provide in the server computer. Thus, the logical volumes are present.
A pool. The pool is a group including a storage area used for thin provisioning and tiering. In FIG. 6, logical volumes are allocated to the pool. However, the parity group or the storage device itself may be allocated directly to the pool.
Virtual volumes. The virtual volumes are virtual storage areas defined using the pool and to which thin provisioning or/and tiering are applied. A term “volumes” may hereinafter be used to indicate the logical volumes and the virtual volumes.
A logical unit (which may hereinafter be referred to as an LU). The logical unit is a storage area from the virtual volumes or the logical volumes which is allowed to be accessed by the server computer 2. A SCSI LUN (Logical Unit Number) is assigned to the logical unit.

The storage controller 3 need not provide all of the above-described types of storage areas.

The NSs may each be associated with any of these types of storage areas. However, the NSs are more preferably associated with the logical unit. This is because this association allows the storage program 320 to easily remain compatible with the storage program 320 for the SAN storage system and makes the definition of the storage areas more compatible with the definition of the storage areas in the SAN storage system.

### Storage Program

The storage program 320 executes the following processes including the above-described items (the storage program 320 need not execute all of the processes):
Receiving, interpreting, and processing a SCSI request. For example, when the SCSI request is a read request, the storage program 320 reads data from the storage device such as the flash memory device 5 or the HDD 6 and transfers the data to the server computer 2. In that regard, the main memory 32 of the storage controller 3 may be used as a cache memory. For example, when the SCSI request is a write request, the storage program 320 stores write data in the cache memory and then writes the write data to the storage device.
Executing a RAID process on the parity group.
Defining the storage areas provided by the storage controller 3. The results of the definition are stored in the main memory 32 of the storage controller 3 as storage area definition information so as to be referenced during the above-described request process.
Executing processes for enterprise functions such as thin provisioning.

### Request Conversion Process in the Candidate (3)

As described above, for the candidate (3), the server side PCIe I/F device 4 generates a SCSI command based on an NVMe command received from the server computer 2 and transmits the SCSI command to the storage controller 3.

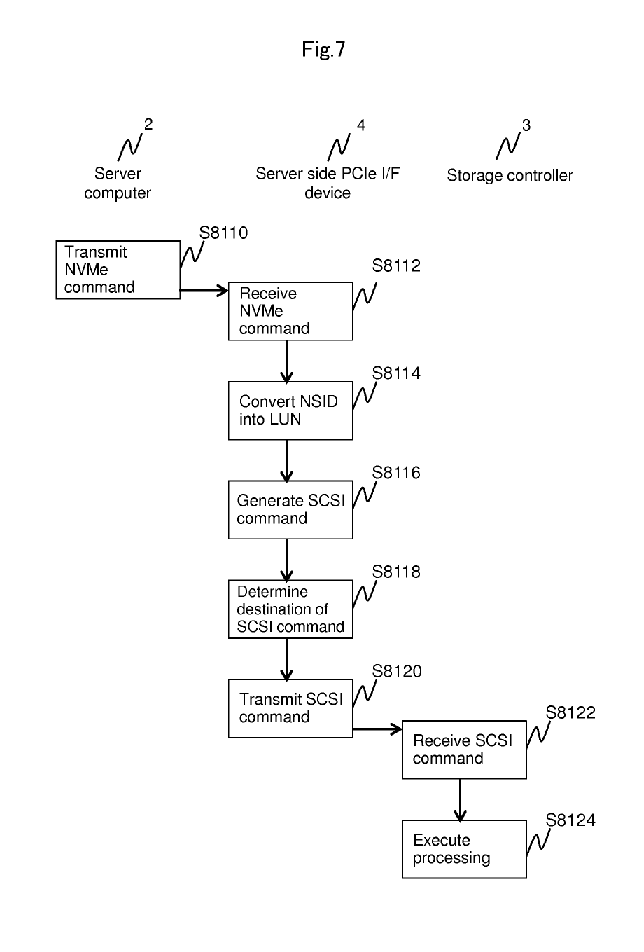

FIG. 7 is a flowchart depicting an NVMe command process executed between the server computer 2, the server side PCIe I/F device 4 and the control unit 36 and associated with an NVMe command. The process described below is applied to a case where the NVMe command is a read command and/or a write command but may be applied to any other NVMe command.

A process procedure is as described below. The following steps assume that the storage controller 3 includes a plurality of control units 36 each including a plurality of CPUs 31 and that the logical unit is associated with the NS:

(S8110) The server computer 2 transmits the NVMe command as a result of the above-described processing executed by the program. The NVMe command contains an NSID to allow a target NS to be specified. The NVMe command also contains the range of access within the NSID and the range of memory for the server computer 2.

(S8112) The server side PCIe I/F device 4 receives the NVMe command.

(S8114) The server side PCIe I/F device 4 interprets the received NVMe command to convert the NSID contained in the command into a corresponding LUN.

(S8116) The server side PCIe I/F device 4 generates a SCSI command containing the resultant LUN.

(S8118) The server side PCIe I/F device 4 determines the control unit 36 and the CPU 31 corresponding to destinations to which the generated SCSI command is to be transmitted.

(S8120) The server side PCIe I/F device 4 transmits the generated SCSI command to the determined destinations.

(S8122 and S8124) The CPU 31 of the destined control unit 36 receives and processes the SCSI command.

The transmission and reception of the NVMe command in S8110 and S8112 correspond to the following process:
(A) A program in execution in the server computer 2 records the NVMe command in an I/O queue prepared in the memory 22 of the server computer 2,
(B) The program in execution in the server computer 2 increments a tail pointer of an I/O queue in an NVMe register space at the EP 41 of the server side PCIe I/F device 4, and
(C) The server side PCIe I/F device 4 detects the increment in the head pointer of the I/O queue to fetch the NVMe command from the I/O queue in the memory 22 of the server computer 2.

In (C), a plurality of NVMe commands may be fetched. In this case, the server side PCIe I/F device 4 executes steps succeeding S8114 on each of the NVMe commands. For the order of execution, S8114 to S8124 may be serially repeatedly or parallelly executed on the NVMe commands.

Although not depicted in the drawings, when the NVMe command is determined to be a write command as a result of the processing in S8124, the server side PCIe I/F device 4 transfers write data stored in the memory 22 of the server computer 2 to the memory 32 of the storage controller 3. When the NVMe command is a read command, the server side PCIe I/F device 4 transfers read data stored in the memory 32 of the storage controller 3 to the memory 22 of the server computer 2.

Furthermore, the conversion of the NSID into the LUN in S8114 may include one of or a combination of the following operations:
The server side PCIe I/F device 4 converts the NSID into the LUN using a predetermined conversion formula (which may include a bit-wise operation). The server side PCIe I/F device 4 may also convert the LUN into the NSID using a reverse conversion formula paired with the predetermined conversion formula. A simple example of the predetermined conversion formula is NSID =LUN.
The server side PCIe I/F device 4 stores a conversion table, that allows the server side PCIe I/F device 4 to obtain the LUN from the NSID, in the memory of the server side PCIe I/F device 4, and references the conversion table during the conversion. As described with reference to FIG. 3, the server side PCIe I/F device 4 may receive the SCSI command issued by the server computer 2 in S8112. In this case, the subsequent steps S8114 and S8116 are omitted, and for handling the SCSI command, the server side PCIe I/F device 4 determines whether the received command is an NVMe command or a SCSI command.

A method for determining the destinations in S8118 may be based on the following criteria but other criteria may be used:
Whether or not there is a failure to the control unit 36 or the CPU 31. For example, the server side PCIe I/F device 4 stores the statuses of the control units 36 resulting from the transmission and performs transmission to the control unit 36 with no fault based on the stored statuses.
The load on the control unit 36 or the CPU 31. In implementation, (A) the storage controller 3 or the management computer 7 acquires the loads on the control units 36 or the CPUs 31 and determines the control unit 36 and the CPU 31 corresponding to destinations to which a SCSI command resulting from a request destined for each NS is to be transmitted, and transmits the destinations to the server side PCIe I/F device 4, and (B) upon receiving the determination results, the server side PCIe I/F device 4 transmits the SCSI command based on the determination results.

### Transmission of an FCP Command Containing a SCSI Command

The server side PCIe I/F device 4 may perform generation of an FCP (Fibre Channel Protocol) command including a SCSI command in addition to the generation of the SCSI command in S8116 and then transmit the FCP command in S8118. This has the following advantages:
The storage program 320 can perform control (access control, priority control, or the like), using a WWN (World Wide Name) or a communication identifier on the SAN such as a port ID generated from the WWN or an IP address.
Compatibility with the SAN storage subsystem can be maintained. This is advantageous both in terms of the storage program and in terms of operations.
The integrated management subsystem can acquire the connection between the server computer 2 and the storage controller 3.

When the FCP command is transmitted, the server side PCIe I/F device 4 has the following:
A virtual server port corresponding to the EP 41 (and to which a virtual WWN is assigned).
A virtual server port corresponding to the EP 42 (and to which a virtual WWN is assigned). The virtual storage port is recognized and treated like a normal SAN port by the storage program 320.

The management subsystem can specify which of the volumes is used as an NVMe NS by defining the logical unit for the virtual storage port. A process flow for the management subsystem is as follows:
(S01) The management subsystem receives a logical unit definition request specifying the storage port and the volume.
(S02) If the specified storage port is not a virtual storage port, the management subsystem transmits, to the storage controller 3, an instruction to define a logical unit corresponding to the specified volume for the storage port specified as is the case with the SAN storage subsystem.
(S03) If the specified storage port is a virtual storage port, the management subsystem transmits, to the storage controller 3, an instruction to define a logical unit corresponding to the specified volume for the specified virtual storage port.

Upon receiving the instruction in S03, the storage controller 3 executes the following processing:
(S03-1) The storage controller 3 selects the server side PCIe I/F device 4 corresponding to the specified virtual storage port.
(S03-2) The storage controller 3 defines a logical unit corresponding to the specified volume (that is, assigns an LUN to the specified volume).
(S03-3) The storage controller 3 reports the assigned LUN to the selected server side PCIe I/F device 4. The server side PCIe I/F device 4 configures the reported LUN to serve as an NS by assigning an NSID to the LUN. In this assignment process, the server side PCIe I/F device 4 generates an NSID, and if the conversion information between the NSID and the LUN is used, generates and records the information.

The process flow for the management subsystem has been described. Thus, the administrator can specify to which of the server computers 2 a volume is provided as NVMe, by specifying a virtual storage port. The specification can be achieved because each of the server side PCIe I/F devices 4 has a virtual storage port and is not shared by a plurality of server computers 2. Furthermore, when the storage controller 3 has a performance monitoring function of the logical unit, one server computer 2 is identified which imposes a load on the logical unit. As a result, the server computer 2 that imposes a load can be quickly identified. When a plurality of server computers 2 accesses a certain volume serving as a shared NS, the above-described logical unit definition is performed on each of the virtual storage ports of the server computers 2 that share the volume.

The above description is specifically intended for the FCP. However, if the description is intended for PDUs (Protocol Data Units) of iSCSIs (Internet Small Computer System Interfaces) or Ethernet frames instead of the FCP, the WWN in the above description may be replaced with an IP address or a MAC (Media Access Control) address. For generalization, the WWN in the above description may be replaced with the communication identifier (which means to include a WWN, an IP address, and a MAC address).

The management subsystem may provide a configuration mode that guards the logical unit definition for a SAN port against volumes serving as NVMe NSs. This is because, in an operation form where only temporary data are stored in the NSs, the logical unit for the SAN port may cause an unintended data update. Or, when the OS recognizes a volume both through a NS path and through a LUN path of SAN, the OS recognizes the volume as different storage areas and may thus execute an update process that leads to a data mismatch. The present guard mode can avoid such a data mismatch.

### Method for Booting the CPF

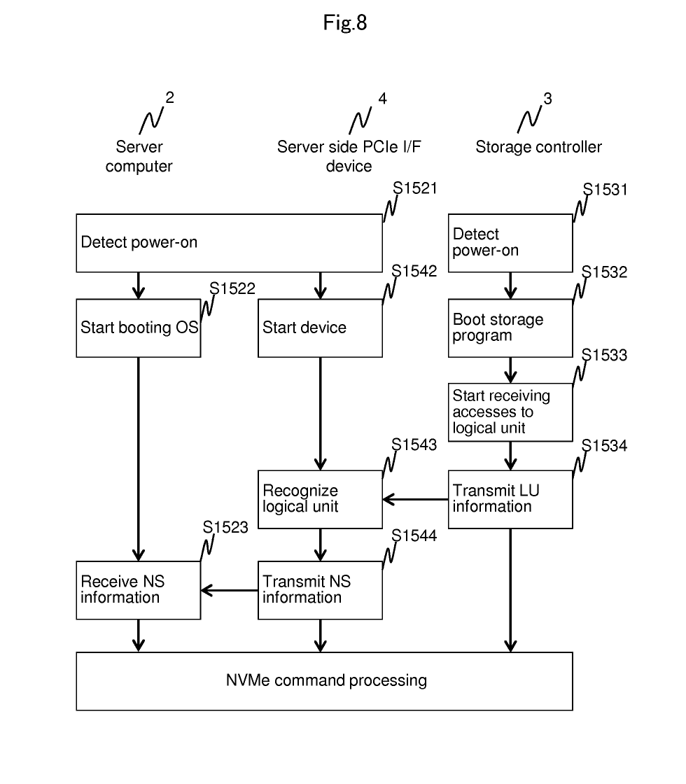

FIG. 8 is a flowchart depicting a method for booting the CPF 1. (S1531, S1532, and S1533) Upon detecting power-on, the storage controller 3 boots the storage program 320 to start accepting accesses to the logical unit.

(S1534) The storage controller 3 transmits logical unit information (an LUN and the like) to the server side PCIe I/F device 4. The storage controller 3 may perform the transmission in accordance with a request from the server side PCIe I/F device 4 or voluntarily.

(S1521) The server computer 2 and the server side PCIe I/F device 4 detect power-on.

(S1542 and S1543) The server side PCIe I/F device 4 is started to receive the logical unit information received from the storage controller 3, thus recognizing the logical unit.

(S1544) The server side PCIe I/F device 4 generates NS information (an NSID and the like) corresponding to the recognized logical unit and transmits the NS information to the programs executed by the server computer 2. In this case, the server side PCIe I/F device 4 is expected to perform the transmission in accordance with a request from the programs in the server computer 2 but may perform the transmission voluntarily. The present step may be executed as a part of the starting of the device 4 or after the starting.

(S1522) The server computer 2 boots the programs such as the OS 227 and the application 228. Programs that need to recognize the NSs wait to receive the NS information (NSIDs and the like). (S1523) In the server computer 2, the programs that need to recognize the NSs receive the NS information from the server side PCIe I/F device 4. As depicted in FIG. 8, when the reception in S1523 is performed, the starting of the storage controller 3 and the server side PCIe I/F device 4 has been completed. The present step may be executed as a part of the booting in S1522 or after the booting.

After the above-described process, the processing of the NVMe command described with reference to FIG. 7 is executed. As depicted in FIG. 8, power-on of the storage controller 3 is independent of power-on of the server computer 2 (and the server side PCIe I/F device 4). However, as a part of steps S1531 to S1533, the storage controller 3 may give an instruction to power the server computer 2 (and the server side PCIe I/F device 4) on.

### <Case Where the NVMe Interpretation Section is the Candidate (2)

FIG. 9 is a diagram depicting the details of the CPF 1 in which the above-described NVMe interpretation section is the candidate (2). Differences from FIG. 4 are as follows:
The server side PCIe I/F device 4 is replaced with a PCIe switch (SW) 9.
A storage side PCIe I/F device 8 is newly installed in the storage controller 3. The device 8 is similar to the server side PCIe I/F device 4. However, in the device 8, the number of EPs 51 connected to the server computers 2 is set to be at least the number of the server computers 2 in order to solve the above-described “coexistence of a plurality of RCs” problem by providing the EPs 51 to each of the server computers 2. Moreover, the device 8 provides EPs 52 to RCs 33 in the storage controller 3.

The storage side PCIe I/F device 8 may execute an NVMe command process in accordance with the flow described with reference to FIG. 7. However, the device 8 may perform an efficient NVMe queue control considering with the internal status of the storage controller 3, by cooperating with the storage program 320, as described with reference to FIG. 1. For example, the NVMe command process lowers the priority of fetch from an NVMe queue related to an NS allocated to an HDD with load concentration or a fault. Furthermore, the storage side PCIe I/F device 8 may convert the NVMe command into a command format other than a SCSI format or transmit the NVMe command to the storage program 320 without any change.

### <Application of the CPF 1

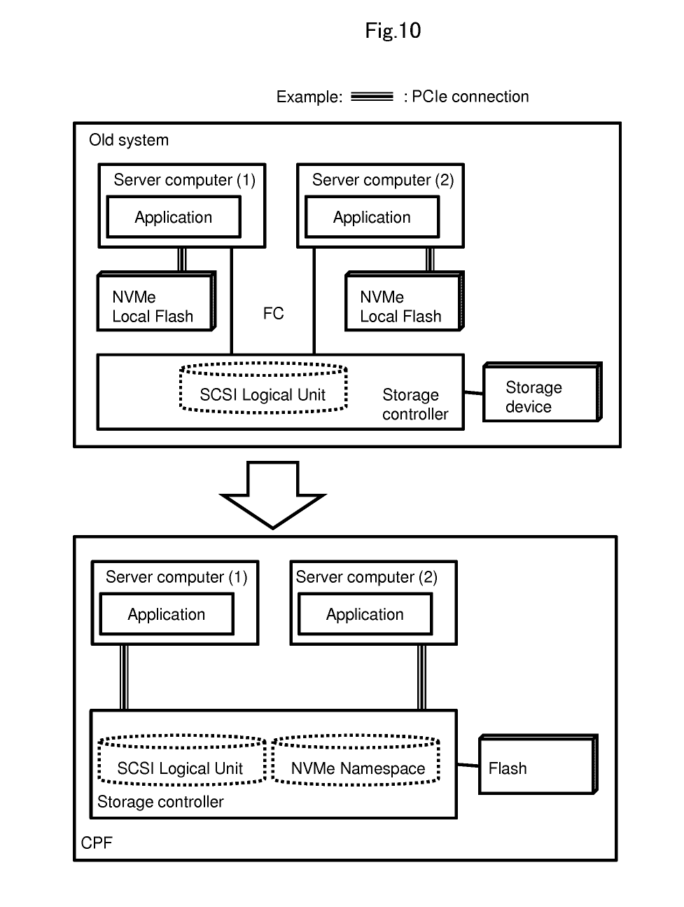

FIG. 10 depicts an example of application of the above-described CPF.

A case will be described when an application executed by an old system is shifted to the CPF. The old system includes a server computer (1), a server computer (2), two local flash memory devices (abbreviated as NVMe Local Flash in FIG. 10), a storage controller, and a storage device. The two local flash memory devices are connected to the server computers (1) and (2), respectively, based on PCIe. The storage controller is connected to the server computers (1) and (2) based on FC. The server computer (1) executes the application. The storage controller uses the storage device to provide a logical unit that supports SCSI (represented as SCSI Logical Unit in FIG. 10).

It is assumed that, in the old system, the application is utilized in accordance with the following configuration:
For the application, temporarily generated data are stored in the NSs in the local flash memory device supporting NVMe, and non-temporary data are stored in the logical unit provided by the storage controller. Thus, the application achieves high-speed processing.
If the server computer (1) is stopped, the server computer (2) resumes a process executed by the application. However, the server computer (2) fails to take over the data stored in the local flash memory device by the server computer (1), and thus read the data from the logical unit via FC to resume the processing.

Such an application can be shifted from the old system to the CPF. The CPF includes a server computer (1), a server computer (2), a storage controller, and a flash memory device (abbreviated as Flash in FIG. 10). The CPF uses the flash memory device connected to the storage controller instead of the local flash memory device connected to each of the server computers. The storage controller provides a logical unit that supports SCSI and a namespace that supports NVMe (represented as NVMe Namespace in FIG. 10), by using the flash memory device. The application in the server computer (1) executes a process by writing temporary data to the NS, which is a shared data area, and reading the temporary data from the NS. Upon determining to take over the process executed by the application in the server computer (1) to the server computer (2) as a result of a fault in the server computer (1) or the like, the server computer (2) reads the temporary data from the NS and takes over and executes the process.

Such a configuration has the following advantages:
Maintenance of the flash memory device can be consolidated.
Using the enterprise functions of the storage controller for the flash memory device allows enhancement of reliability, redundancy, functionality, maintainability, and manageability.

Moreover, if the configuration of the application is changed such that the temporary data stored in the NS are taken over from one of the server computers to the other, the amount of time can be reduced which is needed to switch from the server computer (1) to the server computer (2), as a result of a fault or the like. Thus, the MTBF (Mean Time Between Failure) of the application is improved, and the switching between the server computers is facilitated, So that the maintainability and the manageability are improved. Furthermore, the non-temporary data conventionally stored in the logical units of the SCSI be stored in the NVMe NS, thus further enhancing the application processing performance.

The computer system may include an intermediate device or the like as an interface device. The computer system may include, as a communication mechanism, a substrate such as a backplane or the like, or include, as a communication mechanism, a chassis of a blade server system, a chassis of a storage controller, a cable for PCIe connection, or the like. The computer system may include a chassis, a rack, or the like as a housing that houses a plurality of server computers, a storage controller, and a communication mechanism. The server computer may include the RC 24 or the like as a server side RC. The server computer may include the RC 33 or the like as a storage side RC. The interface device may provide the EP 41 or the like as a first EP and provide the EP 41 or the like as a second EP and which is different from the first EP. The interface device may provide the EP 42 or the like as a third EP. The server computer may use the temporary data, data needed for takeover, or the like as first data and use data not needed for takeover as second data. The computer system may include a local flash memory device or the like as a local nonvolatile memory device.

The embodiment has been described. Some of the above-described points may also be applied to the SCSI commands other than the NVMe commands.

As described above, we explained following points.

<Point 1> A computer system comprises a first server computer; a second server computer; a nonvolatile memory device; and a storage controller connected to the first server computer and the second server computer via PCI-Express, and connected to the nonvolatile memory device. The storage controller provides a storage area in the nonvolatile memory device as a shared data area for the first server computer and the second server computer. A server computer, which is each of the first and second server computers, stores a program that issues an NVM-Express command that is a command conforming to an NVM-Express standard. The program instructs the server computer to access the shared data area via PCI-Express by instructing the server computer to issue the NVM-Express command that specifies a namespace associated with the shared data area.

<Point 2> The computer system further comprises an interface device intermediating between the server computer and the storage controller, by being connected to the server computer via PCI-Express and to the storage controller via PCI-Express. The storage controller provides the shared data area by interpreting a SCSI request and accessing the nonvolatile memory device based on the SCSI request. The interface device includes: a logic that provides a first endpoint (EP) to a first server side RC that is a root complex (RC) included in the first server computer; a logic that provides a second EP to a second server side RC that is a RC included in the second server computer; a logic that provides a third EP to a storage side RC that is a RC included in the storage controller; and a logic that interprets an NVM-Express command issued by the server computer and issues a SCSI request based on the interpreted NVM-Express command, to the storage controller.

<Point 3> The storage controller allocates the storage area to a volume, associates the volume and a virtual storage port with a logical unit, and allocates the logical unit to the namespace.

<Point 4> The program instructs the server computer to issue a SCSI request, and the interface device further includes a logic that interprets the SCSI request issued by the server computer and issues a SCSI request based on the SCSI request issued by the server computer to the storage controller.

<Point 5> The computer system further comprises a management subsystem connected to the first server computer, the second server computer, and the storage controller. The management subsystem is connected to an integrated management subsystem that manages the computer system and a network apparatus using a storage area network (SAN), and the management subsystem: (1) converts information of a PCI-Express connection between the first server computer and the storage controller, and a PCI-Express connection between the second server computer and the storage controller, into information of a virtual SAN connection; and (2) transmits the information of the SAN connection to the integrated management subsystem.

<Point 6> The computer system is a converged platform.

<Claim 7> The first server computer executes a process using first data by writing the first data to the shared data area and reading the first data from the shared data area, and upon determining to switch the process from the first server computer to the second server computer, the second server computer executes the process using the first data by reading the first data from the shared data area.

<Point 8> The computer system further comprises a local nonvolatile memory device that is a nonvolatile memory device which is connected to the first server computer via PCI-Express and interprets an NVMe command. The local nonvolatile memory device interprets an NVM-Express command issued by the first server computer to access a storage area in the local nonvolatile memory device based on the NVM-Express command, and the first server computer writes second data different from the first data and used for the process, to the local nonvolatile memory device.

<Point 9> The storage controller provides the shared data area by receiving an NVM-Express command issued by the server computer, interpreting the NVM-Express command, and accessing the nonvolatile memory device based on the NVM-Express command.

<Point 10> The nonvolatile memory device receives, via the storage controller, an NVM-Express command issued by the first server computer, interprets the NVM-Express command, and accesses the storage area based on the NVM-Express command.

### REFERENCE SIGNS LIST

1 CPF

2 Server computer

3 Storage controller

4 Server side PCIe I/F device

5 Flash memory device

6 HDD

7 Management computer

8 Storage side PCIe I/F device

9 PCIe switch

36 Control unit

1. A computer system to be managed by an integrated management subsystem recognizing a SAN, the computer system comprising:
a storage component storing data;
a first processing component coupled to the storage component;
a plurality of second processing components, which are coupled to the first processing component via PCI-Express connections, and which issue access commands to access the data stored in the storage component via the first processing component; and
a management mean configured to provide emulated SAN connections between the first processing component and the second processing components which corresponds to the PCI-Express connections between the first processing component and the second processing components, to the integrated management subsystem.

2. A computer system according to claim 1,
wherein the access commands are NVM-Express commands specifying a namespace.

3. A computer system according to claim 2,
wherein, as the providing of the emulated SAN connections between the first processing component and the second processing components, the management mean is configured to send information about a virtual SAN storage port of the first processing component, to the integrated management subsystem.

4. A computer system according to claim 2,
wherein the first storage component manages a storage area related to the data stored in the storage component, and
wherein, as the providing of the emulated SAN connections between the first processing component and the second processing components, the management mean is configured to receive a definition request of a logical unit based on the storage area, and process to define a namespace corresponding to the storage area.

5. A computer system according to claim 4,
wherein the definition request further specifies a port of the first processing component,
wherein the definition of the namespace corresponding to the storage area is processed, if the specified port is a virtual SAN storage port of the first processing component, and
wherein the management mean is configured to process to define a logical unit to the specified port, if the specified port is a real SAN port of the first processing component.

6. A computer system according to claim 5,
wherein the real SAN storage port is coupled to an apparatus via a SAN, which is managed by the integrated management subsystem.

7. A computer system according to claim 5,
wherein the virtual SAN storage port is virtually provided by an intermediate device existed in the PCI-Express connection.

8. A computer system according to claim 1,
wherein, as the providing of the emulated SAN connection between the first processing component and the second processing components, the management means is configured to send a virtual SAN connection information indicating that the first processing component is coupled to a first one of the second processing components, and the first processing component is coupled to a second one of the second processing components.

9. A method for a computer system to be managed by an integrated management subsystem recognizing a SAN, wherein the computer system includes components at least includes:
a storage component storing data;
a first processing component coupled to the storage component; and
a plurality of second processing components, which are coupled to the first processing component via PCI-Express connections, and which issue access commands to access the data stored in the storage component via the first processing component, the method comprising a step of:
managing the components; and
providing emulated SAN connections between the first processing component and the second processing components which corresponds to the PCI-Express connections between the first processing component and the second processing components, to the integrated management subsystem.

10. A method according to claim 9,
wherein the access commands are NVM-Express commands specifying a namespace.

11. A method according to claim 10,
wherein, the step of the providing of the emulated SAN connections between the first processing component and the second processing components includes a step of sending information about a virtual SAN storage port of the first processing component, to the integrated management subsystem.

12. A method according to claim 10,
wherein the first storage component manages a storage area related to the data stored in the storage component, and wherein, the step of the providing of the emulated SAN connections between the first processing component and the second processing components includes a step of:
receiving a definition request of a logical unit based on the storage area; and
process to define a namespace corresponding to the storage area.

13. A method according to claim 12,
wherein the definition request further specifies a port of the first processing component,
wherein the step of the definition of the namespace corresponding to the storage area is processed, if the specified port is a virtual SAN storage port of the first processing component, and
wherein the step of the providing of the emulated SAN connections between the first processing component and the second processing components includes a step of processing to define a logical unit to the specified port, if the specified port is a real SAN port of the first processing component.

14. A method according to claim 13,
wherein the real SAN storage port is coupled to an apparatus via a SAN, which is managed by the integrated management subsystem.

15. A method according to claim 13,
wherein the virtual SAN storage port is virtually provided by an intermediate device existed in the PCI-Express connection.

16. A method according to claim 9,
wherein the step of the providing of the emulated SAN connections between the first processing component and the second processing components includes a step of sending a virtual SAN connection information indicating that the first processing component is coupled to a first one of the second processing components, and the first processing component is coupled to a second one of the second processing components.
